(19) United States
(12) Patent Application Publication
(10) Pub. No.: US 2007/0276114 A1
(43) Pub. Date: Nov. 29, 2007

(54) POLYURETHANE BASED RESIN COMPOSITION

(75) Inventor: Jose H. Lopes, Ribeirao Preto (BR)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/419,928

(22) Filed: May 23, 2006

(51) Int. Cl. C08G 18/00

(52) U.S. Cl. 528/44

(57) ABSTRACT

A polyurethane-based resin useful, for example, to repair a surface of a rubber-based component includes a pre-polymer component that is combined with a polyol component. The pre-polymer component includes polyisocyanate, hydroxyl terminated poly-butadiene and ether diol. The polyol component include aliphatic oil, hydroxyl terminated poly-butadiene and aromatic diamine. The polyol component and the pre-polymer component are combined for a selected amount of time to react together and form the polyurethane based resin. The resin may be applied to the surface of a rubber-based component.

### BACKGROUND

The present invention relates to a composition for repairing a damaged rubber-based component. More particularly, the present invention relates to a polyurethane-based resin for repairing a damaged surface of the rubber-based component.

Rubber-based components, whether constructed of a natural, synthetic or modified polymers, are used in a variety of applications including drive belts, coatings and parts of machines. In each of these applications, the rubber-based component has a tendency to become gradually damaged due to wear over time. The rubber-based component can also be suddenly damaged due to an impact with an object.

A typical method for repairing the damaged rubber-based component includes adhering a sheet of rubber-based material to the damaged rubber-based component with either an adhesive or a vulcanizing process. However, the sheet has a tendency of becoming prematurely worn due to an irregular and damaged surface of the rubber-based component. The sheet may also create a seam on the surface of the rubber-based component which may accelerate the wear of sheet.

### SUMMARY OF THE INVENTION

The present invention includes a polyurethane-based resin that may be utilized to repair a surface of a rubber-based component. The polyurethane-based resin includes a pre-polymer component that is mixed with a polyol component. The pre-polymer component comprises at least one polyisocyanate, at least one hydroxyl terminated poly-butadiene and at least one ether diol. The polyol component generally comprises a castor oil, at least one hydroxyl terminated poly-butadiene and at least one aromatic diamine. The pre-polymer component and the polyol component are mixed for a selected amount of time and allowed to react together and form the polyurethane-based resin. The polyurethane resin is useful for application to the surface of the rubber-based component.

### DETAILED DESCRIPTION OF ILLUSTRATIVE EMBODIMENTS

The present invention includes polyurethane-based resins. The resins are useful, for example, in the repairing of rubber-based components. The polyurethanes of the invention are generally abrasion resistant, resistant to water and hydrocarbons such as oil and grease and, when applied to a rubber-based component, become cured (or fixed) in a relatively short period of time. The polyurethanes of the invention typically provide utility over a wide range of temperatures, e.g., from about −10° C. to about 80° C.

Preferred polyurethane resins include those thermosetting resins or resins capable of forming tight cross-linked polymer structures that may be characterized by toughness, adhesion, and relatively low shrinkage. Such resins are typically employed in surface coatings and adhesives.

The polyurethane resins, including those described above, find utility in repairing rubber-based components. Such rubber-based components include any rubber-based material, typically made of a natural, synthetic and/or modified polymers generally with molecular weights of greater than about 10,000. Such components or compositions generally exhibit elastic properties and, after vulcanization, elastic recovery. Specific, exemplary, rubber-based components that may be repaired using the polyurethane-based resins of the invention include drive belts, hoses, coatings or other myriad industrial machinery components and devices.

The invention generally includes a two part system that comprises a pre-polymer component and a polyol component that when mixed together form a “thixotropic” polyurethane-based resin. The term “thixotropic” generally refers to a property of a liquid or liquid mixture that when agitated, stirred and/or mixed form a gel, a paste or otherwise attain a semi-solid state. The pre-polymer component and the polyol component may be mixed together in selected ratios that are effective to produce a non-sag (i.e., resistant to downward movement), thixotropic polyurethane useful in repairing a damaged area of the rubber-based component.

The pre-polymer component generally includes at least one polyisocyanate, at least one poly-butadiene hydroxyl terminated resin and at least one ether diol. Other components can also be added to the pre-polymer component including, but not limited to, a plasticizer. Typical ranges of the components of the pre-polymer component follow in Table 1.

TABLE 1

| Component | Weight percent |
|---|---|
| Polyisocyanate | 40-60 |
| Poly-butadiene resin | 15-25 |
| Ether diol | 5-12 |
| Phthalate plasticizer | 10-20 |

The pre-polymer may be prepared by mixing or otherwise combining the polyisocyanate and the active hydrogen-containing materials including the poly-butadiene hydroxyl terminated resin, the ether diol and the optional plasticizer in a nitrogen atmosphere at a temperature between about 45° C. and about 110° C. for a time sufficient to form a homogenous mixture. The homogenous mixture will generally include less than 11 weight percent isocyanate due to reactions that occur with the poly-butadiene hydroxyl terminated resin and the ether diol. The homogenous pre-polymer is then preferably packaged in a container having a substantially oxygen free atmosphere.

Useful polyisocyates include those sold under the trade names “Isonate 143” by Dow Chemical Company of Midland, Mich.; “Desmodur 1806” by Bayer Aktiengesellschaft of Leverkusen, Germany; and “Rubinate” by Huntsman International LLC of Salt Lake City, Utah. Useful liquid poly-butadiene hydroxyl terminated resins include those sold under the trade names “Liquiflex H” by Petroflex of Wilmington, Del. and “HT 45” by Sartomer of Exton, Pa. Useful ether diols include those sold under the trade names “Voranol 2120” and “Voranol 2040,” by Dow Chemical Company of Midland, Mich. Useful plasticizers include dioctyl phthalate and di-isononyl phthalate, both of which are commercially available from Scandiflex of Sao Paulo, Brazil.

The polyol component includes, for example, one or more common aliphatic oils such as castor oil (preferably having an acidity of less than or equal to 0.8 measured as mg KOH/mg oil; one or more hydroxyl terminated poly-butadienes; and at least one aromatic diamine. The blend of the oil with the hydroxyl terminated poly-butadiene minimizes water absorption into the polyurethane and thereby imparts hydrolytic stability to the polyurethane when applied to the rubber-based component.

The aromatic diamine, for example diethyl toluene diamine, acts as a thixotropic agent by cross-linking polymer chains to form a cross-linked structure that thickens the polyurethane to a paste when the pre-polymer component is mixed with the polyol component. A typical aromatic diamine is diethyl toluene diamine manufactured by Huntsman International LLC of Salt Lake City, Utah. Other thixotropic agents that can be utilized in the polyol component include amide waxes, hydrolyzed castor oil and urea derivatives that are produced in an inert carrier such as plasticizers and hydrocarbons.

The polyol component may also optionally include other ingredients including, but not limited to, fillers, plasticizers, carbon blacks, silanes, water scavengers (such as a zeolite) and anti-oxidants. Typical fillers include inorganic salts such as aluminum silicate, magnesium silicate and calcium carbonate as well as other inorganic salts. The filler can be added to the polyol component as a thixotropic agent and can also be employed to increase the abrasion resistance of the polyurethane when applied to a rubber-based component.

Carbon black may be added to the polyol component as a pigment to color the polyurethane a black color that is similar to the color of the rubber-based component. Utilizing carbon black as a pigment in the polyurethane can minimize the appearance of the repaired surface on the rubber-based component.

A plasticizer is typically added to the polyol component to increase the flexibility of the fixed or cured polyurethane that is adhered to the rubber-based component. Typical plasticizers include dioctyl phthalate and di-isononyl phthalate, both of which are commercially available, for example, from the Scandiflex Corporation of Sao Paulo, Brazil.

An antioxidant can be added to the polyol component to prevent the oxidation of at least the hydroxyl terminated poly-butadiene, as oxidation of the unsaturated components of the polyurethane can cause the polyurethane to degrade over time.

One or more silane components can also be added to the polyol component to increase the adhesion of the polyurethane to the surface of the rubber-based component. Typical silanes include organosilane commercially available, for example from the General Electric Corporation under the product designation “A1170.”

Typical ranges (by weight percents) of the components comprising the polyol component follow in Table 2.

TABLE 2

| Ingredient | Weight percent |
|---|---|
| Castor oil | 40-60 |
| Phthalate plasticizer | 5-12 |
| Aluminum silicate | 20-30 |
| Poly-butadiene resin | 7-15 |
| Amino silane | 0.2-1.0 |
| Antioxidant | 0.4-0.8 |
| Aromatic diamine | 0.5-2.0 |
| Zeolite | 2.5-4.0 |
| Carbon Black | 0.5-1.5 |

The ingredients of the polyol component are preferably mixed together in an environment substantially free of oxygen in a manner to produce a homogenous mixture. The polyol component is preferably then packaged in a substantially oxygen free environment to prevent oxidation of the ingredients.

When using the polyurethane-based resins to repair a rubber-based component, the surface of the component is preferably prepared to accept the resin prior to mixing the polyol component and the pre-polymer component to form the polyurethane. Such surface preparation typically will include removal of moisture and surface contaminants such as dust, paint and sand. After removal of the moisture and the contaminants, the surface is also preferably abraded with a rubber rasp or other abrading tool (such as a wire wheel attached to a grinder). The abrading roughens the surface of the rubber-based component and typically releases oils and grease from the rubber-based component which are removed with an industrial cleaner.

The surface may also be wiped with a clean cloth until the surface is substantially residue free. The surface may be considered sufficiently clean to accept the resin when the cloth no longer picks up rubber-based component residue when the cloth is wiped over the surface.

When the surface of the rubber-based component is prepared, the polyol component and the pre-polymer component can then be mixed or otherwise combined in selected ratios to prepare the polyurethane-based resin. The pre-polymer component and the polyol component are generally combined in the range of between 40 weight percent of the pre-polymer component and 60 weight percent of the polyol component and 30 weight percent of the pre-polymer component and 70 weight percent of the polyol component or any ratio there between.

As the polyol component and the pre-polymer component are combined, an exothermic reaction occurs which increases the temperature of the polyurethane. After combination of the polyol component and the pre-polymer component for about 60 seconds, the polyurethane resin typically obtains a consistency of a paste due to the thixotropic agents.

The polyurethane resin may be applied to the surface of the rubber-based component with any suitable tool, e.g., with a spatula or putty knife. After completing the application of the resin to the rubber-based component, the polyurethane is typically cured for an amount of time sufficient to harden the resin and adhere it to the rubber-based component. Generally, the resin cures for about 90 minutes before the rubber-based component can be placed safely back into use.

Generally, while the polyurethane cures in about 90 minutes, the resin sufficiently hardens in about 7 minutes after mixing to prevent further application of the polyurethane to the rubber-based component. It is therefore generally beneficial to have the surface of the rubber-based component prepared prior to preparation of the resins of the invention.

### EXAMPLES

The following examples are illustrative only and are not intended to limit the present invention.

### Example 1

A vulcanized rubber conveyor belt with a damaged surface was repaired using the polyurethane-based resin of the present invention. Prior to mixing the polyurethane, the damaged surface was prepared by removing substantially all moisture and surface contaminants, such as dust, paint and sand. The surface was abraded to roughen the surface to better accept the polyurethane-based polyurethane. During the abrading process, greases and oils were released and were removed with a cleaner. The surface was then wiped clean with a white cloth until no black residue adhered to the cloth.

After preparing the surface, the polyol component and the pre-polymer component were mixed together at a selected ratio of about 65 weight percent polyol component and about 35 weight percent pre-polymer component. The pre-polymer component and the polyol component were mixed together for about 1 minute to form a paste having a consistency adequate for application to the abraded surface. During the mixing process, an exothermic reaction occurred which raised the temperature of the polyurethane to about 60° C. at a maximum.

The paste was applied to the conveyor belt with a spatula to rebuild the damaged surface. Because the polyurethane had non-sag properties, the paste retained the desired shape and did not flow off an edge of the conveyor belt. About 5 to 7 minutes after the formation of the paste, the polyurethane hardened to a consistency that was incapable of being applied to the conveyor belt.

The resin became tack free after about 30 minutes at about 25° C. After about 2 hours at about 25° C., the resin has sufficiently cured to allow the conveyor belt to be placed back into service as tested using the protocol of ASTM D2240.

The composition of the pre-polymer is utilized to repair the conveyor belt reproduced below in Table 3.

TABLE 3
Pre-polymer component composition

| Ingredient | Weight percent |
|---|---|
| Polyisocyanate | 50.10 |
| Poly-butadiene resin | 23.20 |
| Ether diol | 13.70 |
| Phthalate plasticizer | 23.20 |
| Total | 100.00 |

The composition of the polyol component utilized to repair the conveyor belt reproduced below in Table 4.

TABLE 4
Polyol component composition

| Ingredient | Weight percent |
|---|---|
| Castor oil | 45.00 |
| Dioctyl phthalate | 13.00 |
| Aluminum silicate | 23.00 |
| Poly-butadiene resin | 13.00 |
| Amino silane | 0.4 |
| Antioxidant | 0.2 |
| Diethyl toluene diamine | 2.7 |
| Zeolites | 2.0 |
| Carbon Black | 0.7 |
| Total | 100.0 |

The physical properties of the polyol component and the pre-polymer component prior to mixing are summarized below in Table 5.

TABLE 5

| | Pre-polymner | |
|---|---|---|
| Physical property | composition | Polyol composition |
| Phase | liquid | liquid |
| Color | yellow | black |
| Density (ASTM D 638) (g/cm3) | 1.10 | 1.35 |
| Viscosity (ASTM D 792) (cP) | 1,250 | 15,000 |
| Flash point (ASTM D 92) | >150° C. | >150° C. |

After 24 hours the polyurethane had the following properties as listed in Table 6.

TABLE 6

| Property | Value |
|---|---|
| Water absorption (ASTM D570) | 0.2% by weight |
| Dielectric strength (ASTM D257) | 20 kV/mm-min. |
| Hardness (ASTM D2240) | 70-80 Shore A |

Once returned to service, the conveyor belt was able to perform the desired function for an extended period of time without accelerated wear of the rebuilt surface.

Although the present invention has been described with reference to preferred embodiments, workers skilled in the art will recognize that changes may be made in form and detail without departing from the spirit and scope of the invention.

1. A polyurethane-based resin comprising:
a pre-polymer component comprising at least one polyisocyanate, at least one hydroxyl terminated poly-butadiene and at least one ether diol; and
a polyol component comprising at least one aliphatic oil, at least one hydroxyl terminated poly-butadiene and at least one aromatic diamine;
wherein the polyol component and the pre-polymer component are combined and allowed to react together and form a polyurethane-based resin.

2. The resin of claim 1 wherein the polyisocyanate comprises between about 40 and about 60 weight percent of the pre-polymer component.

3. The resin of claim 1 wherein the hydroxyl terminated poly-butadiene comprises between about 15 and about 25 weight percent of the pre-polymer component.

4. The resin of claim 1 wherein the selected amount of ether diol comprises between about 5 and about 12 weight percent of the pre-polymer component.

5. The resin of claim 1 wherein the pre-polymer component further comprises at least one plasticizer.

6. The resin of claim 5 wherein the plasticizer comprises between about 10 and about 20 weight percent of the pre-polymer component.

7. The resin of claim 1 wherein the aliphatic oil comprises between about 40 and about 60 weight percent of the polyol component.

8. The resin of claim 1 wherein the aliphatic oil is castor oil having an acidity of less than or equal to 0.8.

9. The resin of claim 1 wherein the hydroxyl terminated poly-butadiene comprises between about 7 and about 15 weight percent of the polyol component.

10. The resin of claim 1 wherein the aromatic diamine comprises diethyl toluene diamine.

11. The resin of claim 10 wherein the diethyl toluene diamine comprises between about 0.5 and about 2.0 weight percent of the polyol component.

12. The resin of claim 1 wherein the polyol component further comprises at least one antioxidant.

13. The resin of claim 12 wherein the antioxidant comprises between about 0.4 and about 0.8 weight percent of the polyol component.

14. The resin of claim 1 wherein the polyol component further comprises one or more inorganic salts.

15. The resin of claim 14 wherein the inorganic salt include aluminum silicate.

16. The resin of claim 15 and wherein the aluminum silicate comprises between about 20 and about 30 weight percent of the polyol component.

17. The resin of claim 1 wherein the polyol component further comprises a at least one plasticizer.

18. The resin of claim 17 wherein the plasticizer comprises between about 5 and about 12 weight percent of the polyol component.

19. The resin of claim 1 wherein the pre-polymer component comprises between about 30 and about 40 weight percent of the mixed polyurethane.

20. The resin of claim 1 wherein the polyol component comprises between about 60 and about 47 weight percent of the mixed polyurethane.

21. A method of repairing a rubber-based component comprising:
preparing a pre-polymer component by mixing at least one polyisocyanate, at least one hydroxyl terminated poly-butadiene and at least one ether diol together in a substantially oxygen free atmosphere at a temperature in a range between about 45° C. and about 110° C. for a time sufficient to form a first homogenous mixture;
storing the pre-polymer component in a first container having a substantially oxygen free environment;
preparing a polyol component by combining at least one aliphatic oil, at least one hydroxyl terminated poly-butadiene and at least one diethyl toluene diamine together in a substantially oxygen free atmosphere for a time sufficient to form a second homogenous mixture;
storing the polyol component in a second container having a substantially oxygen free environment;
mixing at least a portion of the pre-polymer component and at least a portion of the polyol component together for a time sufficient to form a paste;
applying the paste to the surface of a rubber-based component and curing the paste on the rubber-based component for a time sufficient for the paste to harden and adhere to the rubber-based component.

22. The method of claim 21 wherein the paste comprises between about 30 and about 40 weight percent of the pre-polymer and between about 60 and about 70 weight of the polyol component.
